(19) United States
(12) Patent Application Publication
(10) Pub. No.: US 2025/0328652 A1
(43) Pub. Date: Oct. 23, 2025

(54) SYSTEMS AND METHODS FOR AUTOMATED CONTINUAL VULNERABILITY REMEDIATION AND VALIDATION

(71) Applicant: Capital One Services, LLC, McLean, VA (US)

(72) Inventors: Payam VAEZI, McLean, VA (US); Urvish PATEL, Reston, VA (US); Neil GOLLAPUDI, McLean, VA (US)

(73) Assignee: Capital One Services, LLC, McLean, VA (US)

(21) Appl. No.: 18/639,904

(22) Filed: Apr. 18, 2024

(51) Int. Cl. G06F 21/57

(52) U.S. Cl. CPC G06F 21/577; G06F 2221/033

(57) ABSTRACT

Systems and methods for continual, automated vulnerability mediation and validation for application development systems are disclosed herein. In some aspects, the system may receive a user input for creating a rebuild code set corresponding to a code sample. The system may store the rebuild code set and the code sample in a container. The system may receive a modification request to generate a modified code sample. The system may execute the rebuild code set on the modified code sample. The system may validate the container based on the modified code sample.

### BACKGROUND

As computer software becomes more complex and integrated into a greater variety of technical applications, computational vulnerabilities may become difficult to detect and manage. A computer vulnerability may include weaknesses or flaws in a computer system, software, hardware, network, or application that may be exploited by malicious entities. For example, vulnerabilities may include software bugs, misconfigurations, design flaws, or human error, leading associated software to be susceptible to software viruses, other malware, software development errors, cyberattacks, unauthorized access, data breaches, or system crashes. As such, the failure to detect and cure vulnerabilities may lead to security breaches, user experience issues, or other undesirable consequences for computing systems. Furthermore, the increased interconnectedness of computational networks and the acceleration of technological developments may lead to changes in the presence or nature of vulnerabilities in given systems, thereby complicating the ability to fix detected software vulnerabilities satisfactorily.

### SUMMARY

Methods and systems are described herein for novel uses and/or improvements to managing vulnerabilities within software applications. As one example, methods and systems are described herein for the automatic rebuilding of application components based on dependency-aware rebuilding instructions that are deployable without user input. For example, the system enables improvements to software rebuild time by automating the detection and management of security vulnerabilities for applications in Continuous Integration (CI) and Continuous Deployment (CD) pipeline management systems for software development (e.g., development of web applications). By doing so, the system enables modular, automated rebuilding of containers within applications to remedy detected vulnerabilities without user input, thereby improving the efficiency with which vulnerabilities may be addressed.

In pre-existing systems, vulnerability management tools may require user input and information for management of vulnerabilities. For example, while a pre-existing system may notify a user of a vulnerability, the pre-existing system may require further input from the user with respect to how to deploy a fix. In some cases, where fixing such vulnerabilities may be time-sensitive, a user's delay may lead to unintended consequences, such as security breaches, data loss, user experience issues, or unauthorized system access. As such, pre-existing systems may suffer from security or compliance issues over time. Furthermore, because pre-existing systems may require user input, such systems may exhibit inconsistent vulnerability fixes across different applications, due to differing user responses to any detected vulnerabilities. For example, in conventional software development, different users may manage different components of an application. Thus, in situations where a new vulnerability is detected that requires modification of a specific component of the application, the system requires manual recreation of the component by each affected user to satisfactorily address the vulnerability. For example, in situations where different applications utilize a given component that is subject to a vulnerability, such fixes must be implemented individually for each of these applications. Thus, pre-existing systems lack a system-wide, consistent, time-sensitive approach to vulnerability management.

Machine learning models may enable improvements to pre-existing vulnerability management systems. For example, artificial intelligence may improve the automated detection of vulnerabilities associated with applications within a given computing system. However, such machine learning models may include complex dependencies themselves and require access to various external or intricate libraries, adding to the potential vulnerability burden on the system. Moreover, while artificial intelligence may enable efficient detection of vulnerabilities, associated machine learning models may still fail to implement any patches or fixes in response to these detected vulnerabilities, thus requiring user input in the system. As such, the implementation of artificial intelligence in vulnerability management may still result in inefficient or untimely handling of detected vulnerabilities within pre-existing systems.

To overcome these technical deficiencies in pre-existing vulnerability management systems, the methods and systems disclosed herein enable storage and execution of rebuild instructions for components within a software application in response to detected vulnerabilities. For example, the system may store rebuild code sets (e.g., instructions) that enable rebuilding containers (e.g., associated with components) of an associated application. The rebuild code sets may include information relating to the container's base image, dependencies, and compilation procedure for the component associated with the container. In response to the detection of a vulnerability, the system may obtain a modification request for modifying the container to address the vulnerability. For example, the system enables generation of a modified code sample that addresses the detected vulnerability through suitable modifications (e.g., to the dependencies within an associated library or associated code). In some embodiments, the system may rebuild the container according to the modified code sample and test this rebuilt container to validate its operation and resilience to the identified vulnerability. By doing so, the system may automatically issue dynamic improvements and modifications to components of containerized applications in a continuous manner, thereby enhancing system security and resilience against threats and weaknesses by reducing the time required to address detected vulnerabilities. For example, the system may consistently and efficiently deploy vulnerability patches to various containerized applications, even where such applications are managed by different entities.

As an illustrative example, the system may improve deployment of software applications with associated containers or components, such as web applications with an associated database functionality. For example, each container (e.g., corresponding to different database management components) may include rebuild instructions (e.g., a Bash script that represents a rebuild code set) that enables generation of code, linking of any associated dependencies, and compilation of the code into an executable format. In response to a detected vulnerability (e.g., a description of an exploitable security issue, as provided by a user associated with an affected component of a container), the system may generate modified code using these rebuild instructions with any required modifications to associated dependencies or features. As such, the rebuild instructions enable rebuilding any containers with the affected component in order to address the detected vulnerability. Thus, the CI/CD system may recompile any affected containers in response to the vulnerability, enabling further testing (e.g., using an automated testing module) within the CI/CD system, as well as subsequent deployment to the target environments. As such, the CI/CD system improves the responsiveness (e.g., the time efficiency) of the system in response to detected vulnerability of components to containers, thereby providing consistent updates to any affected containers within a given application.

In some aspects, the system may receive a first user input creating a first rebuild code set for corresponding to a first code sample. The first rebuild code set may include one or more instructions for automatically rebuilding the first code sample following one or more modifications. The system may store, in a first container, the first rebuild code set and the first code sample. The system may receive a first modification request. The first modification request may modify the first code sample in the first container to generate a first modified code sample. In response to receiving the first modification request, the system may execute the first rebuild code set on the first modified code sample. After executing the first rebuild code set on the first modified code sample, the system may validate the first container based on the first modified code sample.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative schematic of an application with containers associated with application components that enable automated vulnerability management, as well as an application metadata data store, in accordance with one or more embodiments.

FIG. 1B shows an illustrative schematic of a rebuild code set, in accordance with one or more embodiments.

FIG. 1C shows an illustrative schematic of test instruction metadata, in accordance with one or more embodiments.

FIG. 2 shows an illustrative schematic of a vulnerability notification message, in accordance with one or more embodiments.

FIG. 3 shows illustrative components for a system used to rebuild application components in response to the detection of vulnerabilities, in accordance with one or more embodiments.

FIG. 4 shows a flowchart of the steps involved in rebuilding application components to address vulnerabilities dynamically, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

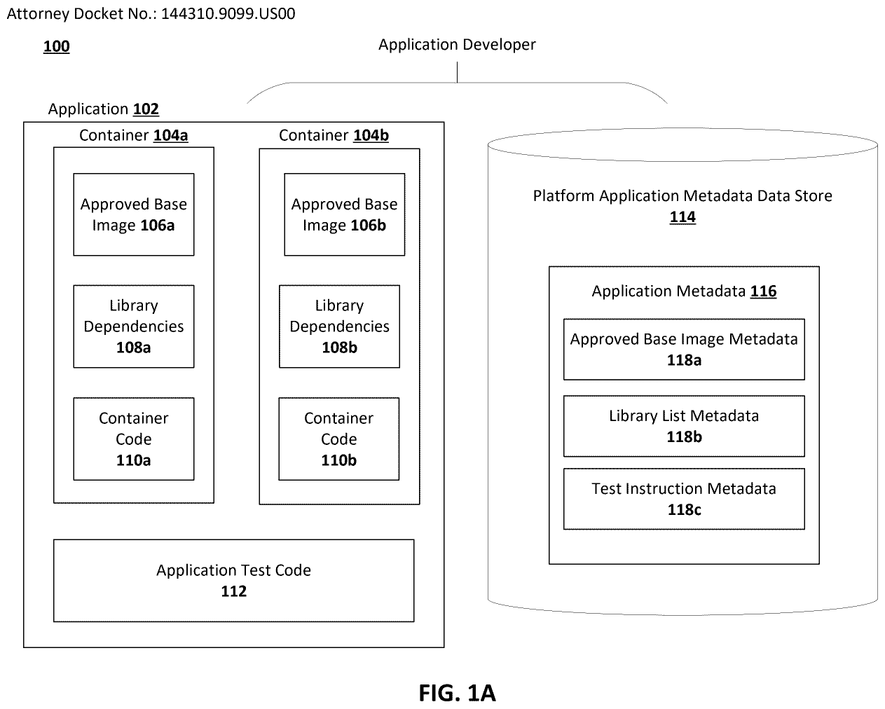

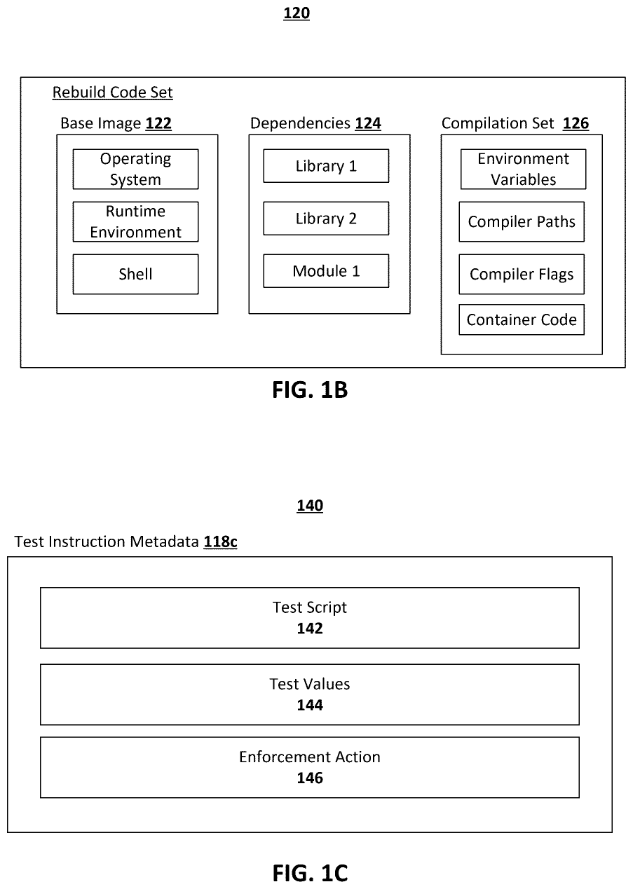

FIG. 1A shows illustrative schematic 100 of application 102 with container 104a and container 104b associated with application components that enable automated vulnerability management, as well as an application metadata data store, in accordance with one or more embodiments. For example, the system enables updating components of application 102, such as components that are associated with container 104a or 104b, based on detected vulnerabilities. As one example, the system enables dynamic, continual deployment of patches or fixes to vulnerabilities (as in a CI/CD system) through automated modification of code samples. By doing so, the system enables efficient handling of detected vulnerabilities, such as weaknesses or bugs in associated software.

In some embodiments, an application (e.g., application 102) may include programs, algorithms, or processes associated with software or hardware and designed to perform tasks or functions for a user or a system. Applications may be associated with desktop, web, mobile or server environments, and may be embedded or integrated into other software, hardware, or suitable devices. An application may include components or modules, such as container 104a or 104b (e.g., as included within a sample codebase) and/or application test code 112. An application may include software managed by a CI/CD framework for software development, whereby the application may be subject to automated development and deployment. For example, an application may include software that is continually tested (e.g., using information within test instruction metadata 118c) and deployed to end users subject to test results. In some embodiments, an application may be used by other applications, programs, or systems (e.g., through an associated application programming interface (API)). The application may communicate with other programs (e.g., through communication interfaces on associated hardware) and, as such, the application may receive inputs from users. For example, an application may be used as a component or a function of other software libraries, projects, systems, or applications. As such, an application enables flexible provision of services and task execution.

In some embodiments, an application may store components (e.g., container 104a or 104b) within a sample codebase. A sample codebase may include code files, modules, or other components (e.g., API calls) associated with the function of the application or portions thereof. For example, a sample codebase may include source code files, documentation, configuration files, assets, test files, build/dependency files (e.g., libraries), version control files, and licenses and legal notices, and may be associated with a directory structure and/or build/deployment scripts. As an illustrative example, the application may store new or modified containers and other modules within the sample codebase, which may be used for rebuilding or generating components. A sample codebase may be associated with a repository or a suitable storage system for code, thereby enabling versioning associated with modifications to code.

For example, the sample codebase (e.g., associated with the application 102) may include one or more components. In some embodiments, a component (e.g., a software component) may include a self-contained and/or reusable piece of code or functionality within a larger software system or application. A component may be capable of performing specific tasks or functions, and may be integrable into software (e.g., applications) to enhance functionality, maintainability, and scalability. For example, a component may include a container (e.g., container 104a), as in a Kubernetes-based system. Additionally or alternatively, a container may include one or more components. For example, software components may be modular and reusable. Components may be generated, maintained, or modified by specific users within a given system. The system disclosed herein may enable updating components associated with applications in response to vulnerabilities in an automated, consistent manner, thereby improving the efficiency and uniformity of vulnerability fixes across an application and/or a larger-scale software development project.

As an illustrative example, application 102 may include components, including one or more containers 104a or 104b. A container may include a standalone, executable package that includes any required components or features. For example, a container may include any code, runtime environments, libraries, testing data, and tools required for operation. In some embodiments, containers may include approved base images 106a or 106b, library dependencies 108a or 108b, and/or container code 110a or 110b. As an illustrative example, a container may include a virtual machine (e.g., a virtual server or node) running an independent operating system. Containers may include isolated environments (e.g., to protect the container from interference from other software or host systems), with controlled interfaces or channels for communication with the application and/or other suitable components. In some embodiments, a container may be utilized within a microservices environment, and may provide one or more functions (e.g., as associated with a software component). Additionally or alternatively, a container may include one or more software components therein, enabling a given container to perform one or more tasks, functions, or processes.

The system may receive application metadata 116 associated with compiling, testing, and/or executing the application 102. For example, application metadata 116 may be stored within platform application metadata data store 114. Application metadata 116 may include approved base image metadata 118a, library list metadata 118b, and/or test instruction metadata 118c. For example, application metadata 116 may be structured in a format associated with the underlying platform (e.g., consistent with a platform metadata schema). By receiving (e.g., from an application developer) information relating to the application, the system improves the ability of the system to modify and/or patch applications on the basis of vulnerabilities or other updates through automated container or application building, thereby improving the efficiency, reliability, and robustness of the CI/CD process without requiring dynamic user input. Test instruction metadata 118c may include information relating to testing containers and/or associated applications, as discussed in relation to FIG. 1C.

For example, approved base image metadata 118a may include information relating to a base image (e.g., approved base image 106a (as described below in relation to FIG. 1B), such as a version number, an image identifier, an operating system identifier, a base image storage location, information relating to base image updates, and/or other suitable information associated with the base image. As such, by retrieving and/or receiving base image metadata, the system may generate and/or update the system (e.g., by searching for and/or finding a base image) in an automated manner without input from users, thereby improving the ability of the system to rebuild containers and/or associated applications.

Library list metadata 118b may include information associated with a library and/or dependencies. For example, the library list metadata may include information relating to the storage locations of dependencies and/or associated libraries within the platform (e.g., through a resource identifier and/or a resource locator). The library list metadata may include information relating to the function and/or descriptions associated with different dependencies, as well as relationships between such dependencies (e.g., information relating to an order in which to install dependencies). The library list metadata may include other suitable information for compilation of the application and/or associated containers on the basis of dependencies or libraries. By retrieving or receiving library list metadata from the platform application metadata data store (e.g., through an associated application developer), the system may retrieve information associated with other programs, applications, or files required for rebuilding or patching a given application, thereby enabling the system to address system vulnerabilities in an automated, efficient process without user or administrator system input.

FIG. 1B shows an illustrative schematic 120 of a rebuild code set, in accordance with one or more embodiments. A rebuild code set may include components associated with rebuilding a component (e.g., container 104a). For example, a rebuild code set may include instructions for rebuilding code samples or other components of a container, application, or application component. A rebuild code set may include a base image 122 associated with the container, any required dependencies 124, and/or a compilation set 126 (e.g., including container code 110a or 110b). In some embodiments, the rebuild code set may include an indication of data to receive, a type of output, testing instructions, and/or compliance requirements. For example, the rebuild code set may include linking instructions, rebuilding scripts, a mechanism for tracking changes (e.g., a tracked repository), and an indication of how to replace existing images. As such, a rebuild code set may include features, components, or functionalities useful for generation or rebuilding of a container.

A rebuild code set may include components or code that enables compilation or building of source code (e.g., code samples) into executable or deployable forms, such as for an application or software artifact. The rebuild code set for container 104a may include a container base image (e.g., base image 122 corresponding to approved base image 106a or 106b). A container base image may include a set of components associated with generation of application containers. For example, a base image may include operating systems, native libraries, and/or associated data, files, or utilities, such as binaries (e.g., operating system packages), language-specific packages, container locations, or other Bash scripts. As shown in FIG. 1B, a container base image may include runtime environments, operating systems, file systems, package management tools (e.g., package managers or software repositories), common system libraries, system utilities (e.g., software shells, such as Bash), security components, user accounts, environment variables and associated configuration files, or kernels. As such, a container base image may include information, processes, algorithms, or programs for generating a functional, self-contained container based on associated code samples or data.

The rebuild code set for container 104a may include an indication of dependencies (e.g., dependencies 124). For example, dependencies may include libraries (e.g., pre-compiled code or functions for use of the container or associated application), modules, software packages, or components for satisfactory execution or maintenance of the container. For example, dependencies may include runtime libraries, frameworks, language-specific packages, or other software required for operation of a given container or application. In some embodiments, a dependency may include libraries, such as collections of pre-compiled codes or functions that may be reusable. For example, a library may require compilation-time linking for full functionality of the container. In some embodiments, a library may be loaded dynamically during runtime of the container. For example, libraries may include dynamic link libraries or shared libraries. As such, libraries and other dependencies may include code, data, or information associated with other systems, applications or third-party servers. As such, a container may include indications of locations (e.g., uniform resource locators or file paths) associated with dependencies and may utilize application programming interfaces (APIs) or other tools to obtain and/or link dependencies to the given container and/or application. In some embodiments, dependencies may introduce or exhibit vulnerabilities. For example, outdated or unpatched vulnerabilities may enable unauthorized access to a given container or application, and/or may cause coding errors. In some embodiments, the system may record changes in dependencies over various modifications. As such, the system may rebuild a given container (e.g., container 104a) using a rebuild code set, where the rebuild code set includes updated dependencies 124, for curing any vulnerabilities caused by any existing dependencies.

A rebuild code set for container 104a may include compilation instructions (e.g., compilation set 126 including container code 110a or 110b). A compilation instruction may include information, data, scripts, executable files, or other components relating to compilation of a program, application, component, or container. For example, a compilation instruction may include information relating to compilation set 126, such as environment variables, compiler paths, or compiler flags. For example, compilation instructions may include target platform flags for optimization of building a software container depending on any associated virtual machines or hardware (e.g., as associated with application 102). Optimization flags associated with the compilation instructions may include flags for tuning performance of an executable file generated by a compiler. In some embodiments, compilation instructions may include compiler paths, such as include paths (e.g., file paths for directories associated with header files or other dependencies, including any code samples used for building the container, such as a modified code sample). For example, compilation set 126 (e.g., compilation instructions) may include information relating to library paths or flags, pre-processor directives (e.g., define statements), debugging information, language standards, warnings settings, platform-specific flags, environment variables, or custom flags. In some embodiments, the compilation set may include a script that is executable by a container's shell (e.g., a Bash script) for automated compilation of a container, subject to any conditions or triggers. For example, in response to a request to rebuild the software according to a given code sample (e.g., as modified in response to a detected vulnerability), the rebuild code set enables generation of an updated container through compilation instructions. As such, compilation instructions enable automated rebuilding of container 104a on the basis of code samples associated with the container, thereby enabling automated, efficient updates to containers based on associated changes in code.

As shown in FIG. 1A, application 102 may include containers and associated code samples (e.g., container code 110a). A code sample may include source code (or a portion thereof) associated with a given container, application, or component. For example, a code sample may include a code snippet associated with a function, a programming concept, or a component (e.g., an object definition, a function definition, or other information associated with a given container), such as a component defined using a pre-determined programming language or programming framework. A code sample may include one or more code strings. A code string may include a string of text (e.g., a set of characters) that represents programming code. For example, a code string may include alphanumeric characters, special characters, or whitespaces, which may be associated with source code, which may be compiled into executable (e.g., machine) code. A code string and/or an associated code sample may be associated with one or more programming languages. As an illustrative example, a code sample may include instructions, algorithms, or processes for operation of a given container (or the associated application). In the context of a CI/CD system, a code sample may include code that defines the functionality of a component to be tested and deployed to end users in a continual manner. In some embodiments, code samples may make use of dependencies (e.g., dependencies 124 shown in FIG. 1B) and other programs, applications, or containers. As such, code samples may be susceptibilities to vulnerabilities and may require continual updates or security improvements. In some embodiments, a code sample may be modified (e.g., by an associated user or system) in response to a vulnerability (e.g., to address a detected vulnerability). For example, upon determination that a given container is susceptible to a computer virus due to a particular component, a user may update the code sample to address the vulnerability (e.g., through the addition of a component-specific firewall or other protective measures). As such, upon execution of a rebuild code set, the system may rebuild the container using the updated, modified code sample, thereby generating a container with the required fixes or improvements.

The modified code sample (e.g., a vulnerability fix) may be generated in response to a detected vulnerability. A vulnerability may include weaknesses or flaws in software applications, systems, or associated components. A vulnerability may be exploitable by malicious entities and, as such, vulnerabilities may compromise the security or functionality of a given application. For example, a vulnerability may include features or elements of an application that are susceptible to malicious attacks (viruses, Trojan horse attacks, or malware). For example, a vulnerability may include coding errors, broken software dependencies, outdated software, unsatisfactory software configurations, inadequate input validation, or a lack of encryption. The system or a user associated with the system may detect a given vulnerability through automated scanning tools, manual code reviews, penetration testing, security audits or assessments, continuous monitoring, log analysis, user reports, or third-party security assessments. A vulnerability may include a security vulnerability, which may include weaknesses that may be exploited to cause security concerns, such as unauthorized access to data, security breaches, or other cyberattacks. In response to detecting a vulnerability associated with a given application, the system may determine, or obtain information relating to, one or more affected components (e.g., containers). As such, the system enables further modifications or changes to code, dependencies, or other components of a given application in order to address the detected vulnerability.

For example, the system may generate one or more modifications (e.g., vulnerability fixes to a code sample associated with a given container). The system may generate a modification to code, where the modification to code addresses an error or a software feature associated with an exploitation or an attack. For example, a modification may include correction of typographic errors, variable declaration errors, or function definitions to avoid exploitability by malicious entities. In some embodiments, the system may extract information relating to the detected vulnerability from a third-party vulnerability database, including information relating to how to satisfactorily address a given vulnerability. The modification (e.g., the modified code sample) may include or modify dependencies associated with the container by generating an associated modified code string within a suitable code sample associated with the container. In some embodiments, the system may receive a modified code sample from the user through a modification request (e.g., through a user input from an associated user device, in the form of a modification request) to address the detected vulnerability. The user input may include textual, audiovisual, or other information associated with the vulnerability or a requested fix for the vulnerability. For example, the system may receive a time-to-action associated with a vulnerability, as well as information relating to the severity of a vulnerability. For example, a system may receive or generate a code sample to address a buffer overflow vulnerability, through the incorporation or modification of code strings associated with input validation, safe functions, memory protection, or a change in programming language associated with the code sample. By doing so, the system may improve its resilience to attacks that exploit buffer overflows, thereby efficiently addressing the vulnerability.

In some embodiments, the system may generate the modified code sample based on modifying a code string on the basis of a data source. For example, a data source may include information, data, or data structures associated with another container, application, or system. As an illustrative example, the system may query another container associated with vulnerability management (e.g., through an associated API) for code strings that may address the detected vulnerability. In some embodiments, the system may check if a new non-vulnerable version of a given base image, compilation dependency, or another container component is published in a metadata catalog or database (e.g., another data source). For example, the data source may be identified through a uniform resource locator or file path and may include sample code strings. In some embodiments, the system may maintain a standardized metadata table of other solutions or fixes to vulnerabilities running on the platform (e.g., associated with other applications or other components of the same application). In some embodiments, the system may determine to generate a notification message for a user associated with a given component, container, or dependency based on an indication that a vulnerability is not included within a data source (e.g., not available within a metadata table). The system may retrieve one or more of these code strings and modify the code sample of the container affected by the vulnerability accordingly, thereby improving the effectiveness of vulnerability management, without requiring user input.

In some embodiments, the system may generate the modified code sample based on modifying a code string on the basis of an output requirement. For example, an output requirement may include a specification or a set of criteria that define or specify expected output or behavior of a program, function, or code sample. For example, an output requirement may specify an expected output in response to an input (e.g., subsequent to a vulnerability fix), as well as functional behavior. In some embodiments, an output requirement may specify performance metrics or error handling requirements (e.g., testing requirements). An output requirement may include compatibility requirements for any modified components or code. In some embodiments, an output requirement may include security requirements, compliance standards, and/or documentation requirements. For example, the system may determine that a vulnerability fix requires compliance with a particular security feature and, on the basis of this corresponding output requirement, the system may modify the code sample to include any code strings or elements that enable the container to satisfy the given security feature. As such, the system may mitigate errors or malicious attacks by ensuring that any modifications satisfy output requirements associated with the container, application, or system as a whole.

In some embodiments, the system may transmit an indication of the vulnerability and/or any affected code samples to an artificial intelligence model in order to generate the modified code sample. For example, the system may provide an original code sample associated with the affected container to the machine learning model, as well as an indication of the type of vulnerability detected (e.g., an indication of a buffer overflow). Additionally or alternatively, the artificial intelligence model may accept information relating to the container to be fixed, such as a rebuild code set (e.g., including an associated base image, dependencies and/or compilation instructions). For example, the artificial intelligence may generate a modified code sample according to attributes, features, or frameworks associated with the relevant container, thereby improving the flexibility and specificity of vulnerability fixes. As such, the machine learning model may generate a modified code sample based on the original code sample, where the buffer overflow issue is addressed (e.g., through the incorporation of an input checking function).

In some embodiments, the artificial intelligence model may be trained on historic rebuild code sets and/or modified code samples. Additionally or alternatively, the artificial intelligence model may include training data that includes vulnerability information, such as the nature of historically detected vulnerabilities. As an illustrative example, the artificial intelligence model may include a generative artificial intelligence model (e.g., a large language model and/or an associated artificial neural network) capable of generating code in response to prompts. As such, the artificial intelligence model may tune and improve predictions on the basis of historic rebuild code sets associated with previously detected vulnerabilities and/or container architectures by updating model parameters, such as model weights, activation functions, biases, or other parameters, to prevent similar vulnerabilities in subsequently detected vulnerabilities. For example, the artificial intelligence model may accept user prompts requesting a modification of a code sample to address an indicated vulnerability. By leveraging machine learning models to generate modified code samples in response to vulnerabilities, the system may improve the flexibility and accuracy of vulnerability fixes by leveraging historic code samples, as well as by considering container-specific solutions to such vulnerabilities (through consideration of the associated rebuild code sets).

FIG. 1C shows illustrative schematic 140 of test instruction metadata 118c, in accordance with one or more embodiments. For example, test instruction metadata 118c may include information associated with testing or validating the operation of the corresponding container and/or application, such as test script 142, test values 144, and/or enforcement action 146. In some embodiments, application 102 may include separate test metadata for the application and associated containers (e.g., application test metadata and/or container test metadata) for testing the functioning of the associated application. As such, test instruction metadata 118c enables validation of fixes or modifications to code samples in response to detected vulnerabilities, thereby enabling the system to prevent erroneous or ineffectual fixes to detected weaknesses.

In some embodiments, a validation test may include a process for validating the operation of a given container, application, or component. For example, the system may validate the operation of container 104a subsequent to the executed rebuild code set on the modified code sample. As an illustrative example, the system may utilize test script 142, stored within platform application metadata data store 114 within test instruction metadata 118c, in order to validate functions, operations, or components associated with the container subsequent to a rebuild (e.g., after modification of the container in response to the detected vulnerability). For example, a test script may include code, operations, processes, or algorithms for verification of whether a vulnerability has been successfully addressed, and/or if the modification generated other issues. For example, a test script may include code that enables verification of the vulnerability, reproduction of the vulnerability, and testing of any boundary conditions (e.g., to ensure that the vulnerability cannot be triggered under any externally imposed conditions). For example, the test script may test various functions associated with a container, including functions or components unrelated to the vulnerability and/or the modified code sample. The test script may test aspects of a deployment of a vulnerability fix (or the corresponding container or application), including dependency imports and solution business logic. For example, the test script may be associated with an executable script as an entry to the container to run a given vulnerability fix (e.g., a solution). For example, the test script may include negative testing, regression testing, or performance testing algorithms, as well as compliance testing. A test script may generate or simulate environments (e.g., container-specific or application-specific) in which to execute the tests, thereby improving the accuracy and applicability of tests. As such, the system enables validation of any implemented modifications or fixes prior to deployment to users in an autonomous, efficient manner, thereby improving the accuracy and timeline for vulnerability fixes.

In some embodiments, the test script may utilize test data (e.g., test values 144) associated with testing the operation of a container, an application, or another component following a vulnerability fix. For example, test values may include input data (e.g., simulated input data or mock data, such as user inputs, sensor readings, or other associated data). In some embodiments, test values may include test data, including data used to test specific application-specific or container-specific functionality (e.g., including configuration information associated with a simulated deployment environment). The test data may include test parameters, test variables, random data, edge cases, error or exception data, or security data. In some embodiments, the system may include expected results (e.g., as defined by output requirements), enabling the test script to compare a test result with an expected result to determine a validation status for the container or application. In some embodiments, the system may include environment data, including information relating to an environment in which the system is being tested, such as network configurations, hardware specifications, or database settings.

In some embodiments, the system may execute the validation test in an environment specific to an application, a container, or another component of the system. For example, an environment may include a combination of hardware, software, configuration settings, and resources in which an application or container (e.g., containerized application) runs. Environments may provide specific and isolated contexts for applications or containers to function, develop, or be tested. As an illustrative example, the validation test (e.g., associated with application test code 112) may be executed on an application-specific environment, including network configurations, hardware configurations, or environment variables associated with the application. In some implementations, the validation test (e.g., associated with test instruction metadata 118c) may be executed on a container-specific environment, including network configurations, virtual node configurations (or hardware configurations), or environment variables associated with an associated container. For example, an environment may specify a particular development environment (e.g., including tools, libraries, or mock services associated with a particular container or application), a specific testing or staging environment, a particular production environment, specific cloud configurations or environments, or any interfaces with other applications or containers. As such, the system enables flexible, robust testing of a given vulnerability fix in a variety of possible environments, thereby improving the testing capabilities and accuracy of the disclosed systems.

In some embodiments, the system may execute validation tests prior to deployment of the application or container. Deployment may include processes associated with enabling access to a software application, system, or components thereof for use in a specific environment, including a production server, a cloud platform, or any other target system. For example, deployment may include configuration and set-up of given software (including fixes or patches, such as in response to a detected vulnerability). For example, deployment may include installation of the application or underlying components, such as containers, within a target system, including any necessary files, libraries, or dependencies. Deployment may include configuration of such files, libraries, or dependencies for compatibility with the target system and the associated environment. For example, deployment may include rollout or scaling, which may be continual and automated as in the case of a CI/CD system. In some embodiments, the system may execute scaling tasks during deployment of an application, including modification of a number of containers, servers, or instances to accommodate a target system. In some embodiments, deployment may include further monitoring or management of the implemented vulnerability fixes. By testing software prior to deployment, the system improves the reliability, availability, and performance of any vulnerability fixes associated with a given application or container thereof.

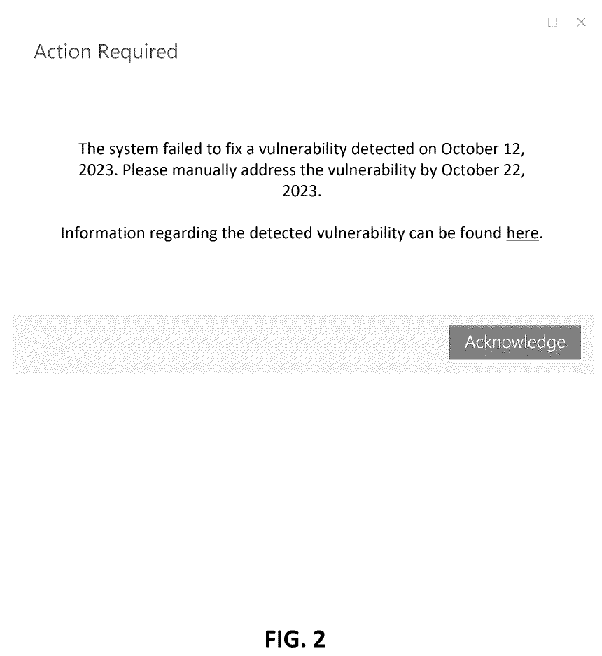

FIG. 2 shows illustrative schematic 200 of a vulnerability notification message (e.g., for display on a graphical user interface), in accordance with one or more embodiments. For example, the system may transmit a notification of any errors or test results associated with a vulnerability fix. In some embodiments, the system may execute a validation test to determine a validation status of a container or an associated application. The system may detect a validation confirmation or a validation failure based on any output requirements or expected test results. In some embodiments, the system may generate notifications that include a vulnerability severity level, as well as a time-to-action (e.g., a deadline for handling the vulnerability). The system may generate notifications periodically (e.g., daily) upon detection that the vulnerability still exists within the system, thereby improving the likelihood of user action against the vulnerability.

In some embodiments, a validation confirmation may include a confirmation, message, or indication (e.g., for display on a graphical user interface) that the container satisfies any requirements associated with the container or application, such as any associated output requirements. For example, a validation confirmation may include an indication that a test script determined that the container or application includes any required functionality or is capable of generating expected outputs in response to test inputs. In some embodiments, the system may determine a validation failure, corresponding to where a container or application is determined to be incompatible with any applicable functionality or performance requirements. For example, a validation failure may include an indication that the validation test generated results that are incompatible with any expected results in response to a test input.

In some embodiments, in response to a validation failure, the system may execute or determine an enforcement action. An enforcement action may include an action, protocol, algorithm, or code sample associated with a response to a validation failure or other detected errors. For example, an enforcement action may include an instruction to generate an alert to the user (e.g., an error notification). In some embodiments, an enforcement action may include a determination to terminate the associated application depending on the nature of the associated detected vulnerability. For example, an enforcement action may include modifications to the modified code sample, including bug fixes, requirement adjustments, code refactoring, regression testing, or curing documentation issues. As such, the system may dynamically cure and solve errors associated with vulnerability fixes accordingly, thereby improving the resilience of the vulnerability management system.

In some embodiments, the system may generate an error notification, where the error notification indicates an error associated with a modification associated with a vulnerability fix. For example, an error notification may include or be in response to an indication that a container or application could not be rebuilt successfully. As an illustrative example, the system may generate an error notification in response to a compilation error (e.g., due to a modified code sample that includes syntax errors). As such, the system may generate an indication of the failure to fix a detected vulnerability, including a request that a user address the vulnerability manually, as shown in FIG. 2. In some embodiments, the system may include, within the error notification, a deadline for the vulnerability fix (e.g., a time-to-action). By generating validation confirmations, validation failures, and/or error notifications to users in response to issues with generation of vulnerability fixes, the system enables improved communication and transparency with users and developers regarding the nature of any pending vulnerabilities, thereby improving the vulnerability mitigation capability of the system.

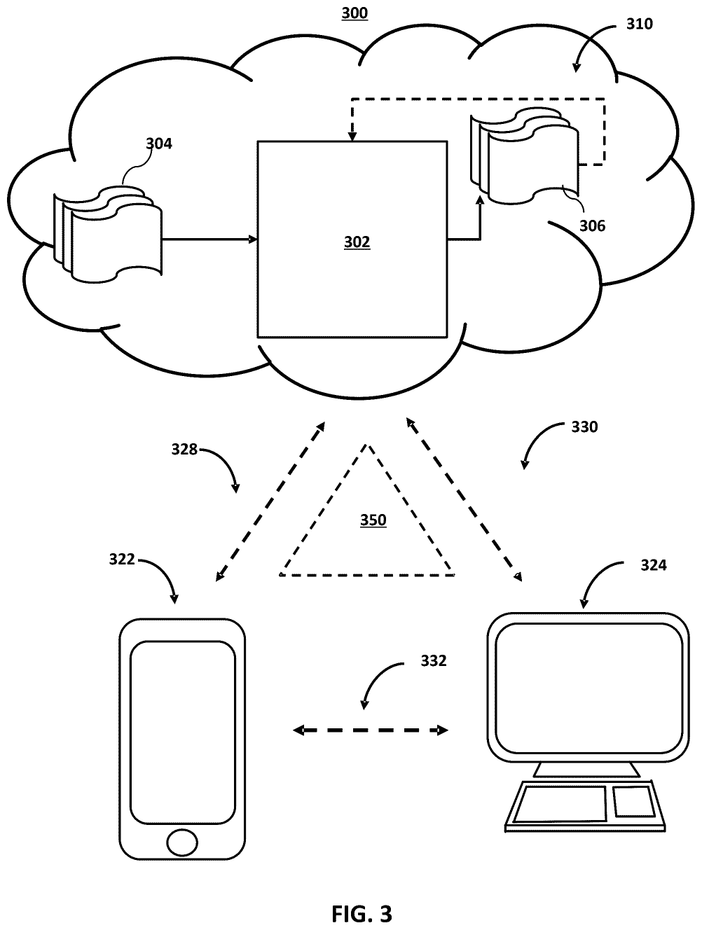

FIG. 3 shows illustrative components for a system used to rebuild application components in response to the detection of vulnerabilities, in accordance with one or more embodiments. For example, FIG. 3 may show illustrative components for improving mitigation of detected vulnerabilities in CI/CD systems for automated, efficient patching of detected vulnerabilities with limited user input. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include applications, containers, and test metadata. For example, cloud components 310 may access rebuild code sets, code samples (or other code associated with an application or container), and associated test metadata. For example, cloud components 310 may include base images, dependencies, and compilation sets, including operating system images, runtime environment information, and shells.

Cloud components 310 may access information relating to dependencies, vulnerabilities, or other systems. For example, cloud components 310 may access libraries, modules, or environments associated with applications or systems. Cloud components 310 may retrieve data from other data sources, such as through APIs with other applications and corresponding containers. Cloud components 310 may access test data for testing the functionality of a container or application; such test data may include test scripts, test values, or enforcement action information.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a likelihood of detection of a given vulnerability, or a prediction for a modified code sample for addressing the detected vulnerability).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., whether a system or application is associated with a vulnerability, or whether a modified code sample (e.g., a vulnerability fix) is validated according to any output requirements or testing standards).

In some embodiments, the model (e.g., model 302) may automatically perform actions based on outputs 306. In some embodiments, the model (e.g., model 302) may not perform any actions. The output of the model (e.g., model 302) may be used to generate a modified code sample to address a detected vulnerability, for deployment to end users in a CI/CD system.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

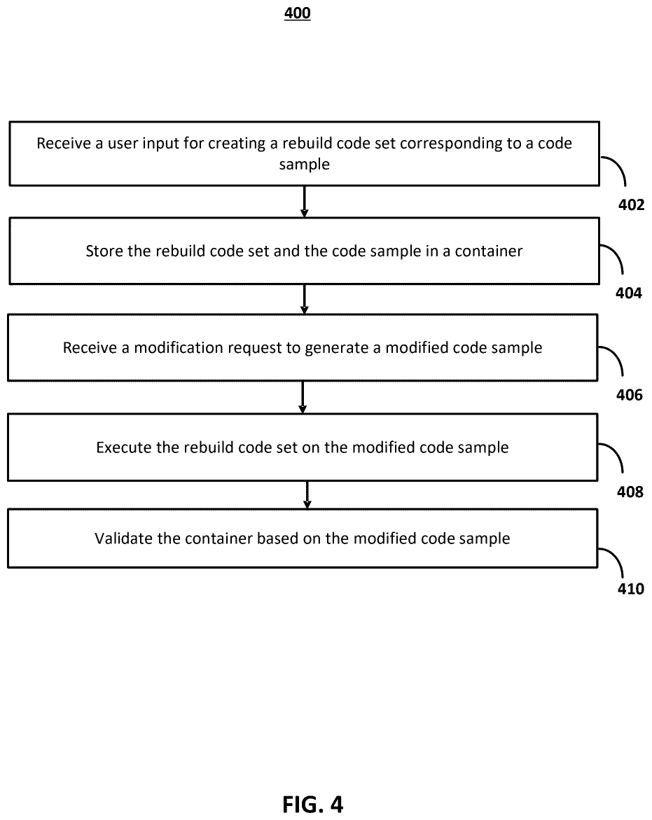

FIG. 4 shows a flowchart of the steps involved in rebuilding application components to address vulnerabilities dynamically, in accordance with one or more embodiments. For example, the system may use process 400 (e.g., as implemented on one or more system components described above) in order to deploy fixes to vulnerabilities in a CI/CD software development system in an autonomous, efficient manner with limited user input.

At operation 402, process 400 (e.g., using one or more components described above) enables the system to receive a user input for creating a rebuild code set corresponding to a code sample. For example, the system may receive a first user input for creating a first rebuild code set corresponding to a first code sample. In some embodiments, the first rebuild code set includes one or more instructions for automatically rebuilding the first code sample following one or more modifications. As an illustrative example, the system may receive an instruction or a data set including information relating to a rebuild code set. For example, the system may receive compilation instructions for compiling a given container (e.g., associated with a database associated with a web application), as well as associated dependencies (e.g., suitable libraries), and any operating system images for operation of the container. The rebuild code set may include information relating to a storage location or a file path to source code or scripts (e.g., a code sample) for operation and compilation of the container (e.g., population of the database and associated functions) or application (e.g., a web application associated with a CI/CD development pipeline). By receiving information relating to rebuilding an application or container, the system enables recompilation of software components where any code samples are modified or updated, thereby improving the flexibility of the system for responding to detected vulnerabilities or attacks.

At operation 404, process 400 (e.g., using one or more components described above) enables the system to store the rebuild code set and the code sample in a container. For example, the system may store, in a first container, the first rebuild code set and the first code sample. As an illustrative example, the system may generate and/or locate a container associated with a component of the application, such as a container associated with a database for a web application. The system may store rebuild instructions, including elements of the rebuild code set, within system memory associated with the associated container. By doing so, the system enables the container to update or refresh according to these rebuild instructions and any suitable source code (e.g., the code sample), thereby improving the system's efficiency and ability to adapt to detected vulnerabilities, such as features that may be exploitable by cyberattacks.

In some embodiments, the system may include a container base image, a dependency library, and a compilation instruction (e.g., within the rebuild code set). As an illustrative example, the system may store an operating system, runtime environment, or shell (e.g., within a base image) associated with a container that is associated with a database functionality, as well as any libraries or modules and compilation instructions (e.g., environment variables, compiler paths, or compiler flags). By doing so, the system may provide information relating to rebuilding a container in light of any modifications or fixes responsive to a detected vulnerability. As such, the system improves the efficiency of rebuilding and redeploying components for applications, thereby improving the efficiency of the system in responding to vulnerabilities.

At operation 406, process 400 (e.g., using one or more components described above) enables the system to receive a modification request to generate a modified code sample. For example, the system may receive a first modification request. The first modification request may modify the first code sample in the first container to generate a first modified code sample. As an illustrative example, the system may modify text strings associated with the container's source code, such as source code associated with a database functionality for a web application. For example, the system may remove, add, or modify lines of code associated with loops or functions that are determined to be associated with a given vulnerability, such as to cure a buffer overflow issue. By doing so, the system enables dynamic, automated updates to source code associated with components of the system in a modular manner, enabling flexible, targeted mitigation of vulnerabilities leading to the system's susceptibility to malicious attacks or other exploitations.

In some embodiments, the system may utilize an artificial intelligence model for modification of the code sample in response to a detected vulnerability. For example, the system may input the first rebuild code set into an artificial intelligence model. In some embodiments, the artificial intelligence model is trained on historic rebuild code sets and modified code samples. The system may receive an output from the artificial intelligence model. The output may include a modification to the first code sample and may correspond to the first modified code sample. As an illustrative example, the system may provide information relating to the vulnerability, such as a description of a buffer overflow vulnerability, as well as the associated source code, to a machine learning model (e.g., an artificial neural network). For example, the artificial intelligence model may be trained on data concerning other similar buffer overflow vulnerabilities, thereby enabling the artificial intelligence model to provide a suggestion for a modified code sample (e.g., through a generative component). To illustrate, the artificial intelligence model may identify security vulnerabilities relating to database injection within the code sample. Based on this identification, the artificial intelligence model may generate a modified code sample that includes input validation processes (e.g., including code snippets that enable the removal of predetermined characters from inputs), thereby improving the security of the system. Accordingly, the system may improve the accuracy and efficiency of modifications to source code, without user input.

In some embodiments, the system may determine a modification to the code sample based on a security vulnerability. For example, the system may detect a first security vulnerability in the first code sample. The system may determine a modification to the first code sample to address the first security vulnerability. As an illustrative example, the system may determine that a communication channel associated with a web application or a corresponding component (e.g., a container) is susceptible to malware, a virus, or a Trojan horse attack. Based on this determination, the system may modify source code of a component of the web application (e.g., corresponding to a container) in order to mitigate or eliminate the component's susceptibility to a security-based attack (e.g., by closing a communication channel or modifying a firewall). By doing so, the system may mitigate vulnerabilities that are associated with system security, thereby protecting the system in a dynamic, efficient manner.

At operation 408, process 400 (e.g., using one or more components described above) enables the system to execute the rebuild code set on the modified code sample. For example, in response to receiving the first modification request, the system may execute the first rebuild code set on the first modified code sample. As an illustrative example, the system may rebuild the container (e.g., associated with a component of a web application, such as a database function) utilizing source code modified in response to the detected vulnerability (e.g., in response to a buffer overflow vulnerability). For example, the system may utilize the rebuild code set and modified code sample to generate a new database-related container (or update the existing container) to include any fixes in response to the buffer overflow vulnerability. As such, the system enables dynamic, modular, and automated fixing of a component in response to a detected vulnerability.

At operation 410, process 400 (e.g., using one or more components described above) enables the system to validate the container based on the modified code sample. For example, after executing the first rebuild code set on the first modified code sample, the system may validate the first container based on the first modified code sample. As an illustrative example, the system may execute a test script using test input data to test and validate the functionalities of the container and/or the application subsequent to the vulnerability fix (e.g., after rebuilding the container on the basis of the vulnerability fix). For example, the system may execute a test script to test data entry or data extraction from a database associated with the container, to ensure that any modifications to prevent buffer overflow vulnerabilities do not interfere with the functioning of database capabilities. By doing so, the system enables validation of any modifications to the application or components thereof and subsequent correction, if warranted.

In some embodiments, the system may generate the modified code sample in response to the detected vulnerability based on an output requirement associated with a component of the application (e.g., a container). For example, the system may determine, based on the first rebuild code set, an output requirement of the first container. The system may modify a first code string in the first modified code sample based on the output requirement. For example, the system may retrieve a specification or a set of criteria specifying expected behavior for the container (e.g., a container associated with a database for a web application). For example, the output requirement may specify a performance criterion or a memory limit associated with accessing data from the database. The system may detect when such a criterion is not satisfied and modify the code sample to address this issue. As such, the system enables dynamic, automated modification of applications based on requirements, specifications, or criteria, thereby improving the system's flexibility and responsiveness to a variety of factors.

In some embodiments, the system may modify a dependency associated with the container's code in response to a detected vulnerability. For example, the system may determine, based on the first rebuild code set, a dependency of the first container on a second code sample, wherein the second code sample is in a second container. The system may modify a first code string in the first modified code sample based on the dependency. As an illustrative example, the system may modify, within the code sample associated with a given container, libraries, modules, or information associated with third-party systems or applications. For example, the system may modify the code sample to remove or exclude libraries associated with databases that are causing errors or are associated with buffer overflow vulnerabilities. As such, the system may mitigate the application's susceptibility to vulnerabilities by modifying dependencies used in compiling the application or the component thereof, thereby improving the system's resilience to exploitative attacks in an efficient, automated manner.

In some embodiments, the system may modify the code sample in response to the detected vulnerability based on a data source associated with another component of the system (e.g., another container). For example, the system may determine, based on the first rebuild code set, a data source of the first container. The data source may include a second container. The system may modify a first code string in the first modified code sample based on the data source. As an illustrative example, the system may retrieve information or data structures associated with another container or component, such as a vulnerability management module associated with a web application. For example, the system may retrieve vulnerability-specific code samples and utilize these specific code samples to modify the container's code sample in response to detected vulnerabilities. As such, the system may leverage pre-existing information associated with other containers or modules in order to mitigate exploitation of vulnerabilities by malicious actors in an efficient manner, thereby reducing the need for user input and enhancing the time efficiency of vulnerability fixes.

In some embodiments, the system may modify the code sample in response to the detected vulnerability based on a validation test for the container (e.g., before or after detection of the vulnerability and subsequent container rebuilding). For example, the system may determine, based on the first rebuild code set, a first validation test for the first container, wherein the first validation test is performed on the first container prior to deployment. The system may modify a first code string in the first modified code sample based on the first validation test. As an illustrative example, the system may utilize a test script to validate the functionalities or operation of the container (e.g., after a previous rebuild in response to a previously detected vulnerability). The test script may include, for example, a script for testing database-related functions, such as data entry or extraction, as associated with a web application. In response to confirming the validation (e.g., through a validation confirmation) or determining a test failure (e.g., a validation failure), the system may modify the code sample. For example, the system may confirm that a given modification causes expected behavior and, as such, may determine to update the code sample to retain the modification. Additionally or alternatively, the system may determine that a modification causes unexpected or unsatisfactory behavior and, as such, the system may determine to modify the code sample further to prevent undesirable effects. As such, the system may adapt to previous modifications to code samples to iteratively improve the accuracy of a given vulnerability fix (e.g., modification to the code sample), thereby improving the effectiveness of such fixes against malicious entities.

In some embodiments, the system may modify the code sample (e.g., a second time) to address the detected vulnerability based on an error notification (e.g., in response to a failure of the container to be rebuilt). For example, the system may determine, based on the first rebuild code set, an error notification triggered in response to failure of the first container to be rebuilt. The system may modify a first code string in the first modified code sample based on the error notification. As an illustrative example, the system may determine a compilation error or a runtime error associated with the container (e.g., after a previous rebuild of the container). For example, the system may determine an error in compiling a database entry generator function and, accordingly, the system may determine to modify the code sample to fix this issue. As such, the system enables dynamic monitoring of compilation or runtime errors in response to modifications made to mitigate detected vulnerabilities, thereby improving the resilience of the system and enabling efficient, automated fixes where errors are detected. By reducing the need for user input, the system improves the time taken to implement vulnerability fixes, thereby reducing the likelihood of malicious, exploitative cyberattacks.

In some embodiments, the system may execute a validation test for the application for modification of the code sample in response to the detected vulnerability. For example, the system may determine, based on the first rebuild code set, an application comprising the first container. The system may determine a validation test for the application. In some embodiments, the validation test may be performed on the application prior to deployment. The system may modify a first code string in the first modified code sample based on the validation test. As an illustrative example, the system may utilize a test script that enables testing of the application as a whole (or, additionally or alternatively, for individual containers or components within the application). For example, the system may execute a validation test that tests the functioning of multiple features associated with a web application, beyond or including a database-specific component. The system may determine to further modify the code sample based on a validation failure, for example. As such, the system may improve the reliability of the system by testing application-wide behavior associated with any vulnerability fixes.

In some embodiments, the system may modify the code sample based on an enforcement action associated with the application. For example, the system may determine, based on the first rebuild code set, an enforcement action for performing on an application comprising the first container in response to a validation failure of the first container. The system may modify a first code string in the first modified code sample based on the enforcement action. As an illustrative example, the system may determine actions or protocols associated with validation. For example, the system may retrieve an enforcement action that includes an instruction to generate an alert to a user (e.g., an error notification), or an instruction to terminate the application depending on the risk associated with the detected vulnerability. As such, the system may enforce any actions or requirements in response to any validation failures or detected errors in the application or the associated container, thereby improving the resilience of the system to errors.

In some embodiments, the system may validate the container based on a validation test in a container-specific and/or an application-specific environment. For example, the system may perform a first validation test on the first container in a container-specific environment. In some embodiments, the system may perform a second validation test on an application comprising the first container in an application-specific environment. As an illustrative example, the system may perform multiple validation tests with different scope; for example, the system may run a first test on a component of the application (e.g., a database manager associated with a web application), and a second test on the functioning of the application as a whole (e.g., a whole web application). As such, the system may ensure that any modifications to the container subsequent to its rebuilding lead to expected behavior. Thus, the system improves the resilience and reliability of the system and prevents the implementation and deployment of fixes that lead to other issues within the affected component, as well as throughout the application.

In some embodiments, the system may validate the container by processing a test script. For example, the system may retrieve a first test script for an application comprising the first container. The system may process the first test script in the application. As an illustrative example, the system may retrieve a test script from a data source or third-party server, where the test script may test the functionality of the application. For example, the system may utilize a Bash script that tests the navigability or functionality of user controls within a web application or associated user interface. Based on determining whether the test succeeds, the system may determine a validation status for the application or the container(s) affected by the vulnerability. By doing so, the system may validate the success of a given modification to a container's source code in the context of the functionality of the underlying application, thereby improving the reliability of automated, efficient fixes in response to detected vulnerabilities.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising: receiving, via a first user interface, a first user input for creating a first rebuild code set for corresponding to a first code sample, wherein the first rebuild code set comprises one or more instructions for automatically rebuilding the first code sample following one or more modifications, and wherein the first code sample corresponds to a first application; storing, in a first container, the first rebuild code set and the first code sample; storing the first container in a sample codebase, wherein the sample codebase comprises a plurality of containers, and where each of the plurality of containers comprises a respective rebuild code set and a respective code sample; receiving, via a second user interface, a second user input, wherein the second user input modifies the first code sample in the first container to generate a first modified code sample, wherein the first modified code sample addresses a first vulnerability detected in the first code sample; in response to receiving the second user input, executing the first rebuild code set on the first modified code sample; and after executing the first rebuild code set on the first modified code sample, validating the first container based on the first modified code sample; and generating for display, on a third user interface, a first validation confirmation for the first container.

2. A method, the method comprising: receiving a first user input for creating a first rebuild code set corresponding to a first code sample, wherein the first rebuild code set comprises one or more instructions for automatically rebuilding the first code sample following one or more modifications; storing, in a first container, the first rebuild code set and the first code sample; receiving a first modification request, wherein the first modification request modifies the first code sample in the first container to generate a first modified code sample; in response to receiving the first modification request, executing the first rebuild code set on the first modified code sample; and after executing the first rebuild code set on the first modified code sample, validating the first container based on the first modified code sample.

3. A method, the method comprising: receiving a first user input creating a first rebuild code set for corresponding to a first code sample, wherein the first rebuild code set comprises one or more instructions for automatically rebuilding the first code sample following one or more modifications; storing, in a first container, the first rebuild code set and the first code sample; receiving a first modification request, wherein the first modification request modifies the first code sample in the first container to generate a first modified code sample; in response to receiving the first modification request, executing the first rebuild code set on the first modified code sample; and after executing the first rebuild code set on the first modified code sample, validating the first container based on the first modified code sample.

4. The method of any one of the preceding embodiments, wherein executing the first rebuild code set on the first modified code sample further comprises: determining, based on the first rebuild code set, an output requirement of the first container; and modifying a first code string in the first modified code sample based on the output requirement.

5. The method of any one of the preceding embodiments, wherein executing the first rebuild code set on the first modified code sample further comprises: determining, based on the first rebuild code set, a dependency of the first container on a second code sample, wherein the second code sample is in a second container; and modifying a first code string in the first modified code sample based on the dependency.

6. The method of any one of the preceding embodiments, wherein executing the first rebuild code set on the first modified code sample further comprises: determining, based on the first rebuild code set, a data source of the first container, wherein the data source comprises a second container; and modifying a first code string in the first modified code sample based on the data source.

7. The method of any one of the preceding embodiments, wherein executing the first rebuild code set on the first modified code sample further comprises: determining, based on the first rebuild code set, a first validation test for the first container, wherein the first validation test is performed on the first container prior to deployment; and modifying a first code string in the first modified code sample based on the first validation test.

8. The method of any one of the preceding embodiments, wherein executing the first rebuild code set on the first modified code sample further comprises: determining, based on the first rebuild code set, an error notification triggered in response to failure of the first container to be rebuilt; and modifying a first code string in the first modified code sample based on the error notification.

9. The method of any one of the preceding embodiments, wherein executing the first rebuild code set on the first modified code sample further comprises: determining, based on the first rebuild code set, an application comprising the first container; determining a validation test for the application, wherein the validation test is performed on the application prior to deployment; and modifying a first code string in the first modified code sample based on the validation test.

10. The method of any one of the preceding embodiments, wherein executing the first rebuild code set on the first modified code sample further comprises: inputting the first rebuild code set into an artificial intelligence model, wherein the artificial intelligence model is trained on historic rebuild code sets and modified code samples; and receiving an output from the artificial intelligence model, wherein the output comprises a modification to the first code sample and corresponds to the first modified code sample.

11. The method of any one of the preceding embodiments, wherein executing the first rebuild code set on the first modified code sample further comprises: determining, based on the first rebuild code set, an enforcement action for performing on an application comprising the first container in response to a validation failure of the first container; and modifying a first code string in the first modified code sample based on the enforcement action.

12. The method of any one of the preceding embodiments, wherein storing, in the first container, the first rebuild code set further comprises storing a container base image, a dependency library, and a compilation instruction.

13. The method of any one of the preceding embodiments, wherein receiving the first modification request further comprises: detecting a first security vulnerability in the first code sample; and determining a modification to the first code sample to address the first security vulnerability.

14. The method of any one of the preceding embodiments, wherein validating the first container based on the first modified code sample further comprises: performing a first validation test on the first container in a container-specific environment; and performing a second validation test on an application comprising the first container in an application-specific environment.

15. The method of any one of the preceding embodiments, wherein validating the first container based on the first modified code sample further comprises: retrieving a first test script for an application comprising the first container; and processing the first test script in the application.

16. One or more tangible, non-transitory, computer-readable media storing instructions that, when executed by a data processing apparatus, cause the data processing apparatus to perform operations comprising those of any of embodiments 1-15.

17. A system comprising one or more processors, and memory storing instructions that, when executed by the processors, cause the processors to effectuate operations comprising those of any of embodiments 1-15.

18. A system comprising means for performing any of embodiments 1-15.

What is claimed is:

1. A system for minimizing software rebuild time due to detected security vulnerabilities during continuous integration and continuous deployment pipeline management using container-based code samples, the system comprising:
one or more processors; and
one or more non-transitory, computer-readable media comprising instructions that when executed by the one or more processors cause operations comprising:
receiving, via a first user interface, a first user input for creating a first rebuild code set corresponding to a first code sample, wherein the first rebuild code set comprises one or more instructions for automatically rebuilding the first code sample following one or more modifications, and wherein the first code sample corresponds to a first application;
storing, in a first container, the first rebuild code set and the first code sample;
storing the first container in a sample codebase, wherein the sample codebase comprises a plurality of containers, and where each of the plurality of containers comprises a respective rebuild code set and a respective code sample;
receiving, via a second user interface, a second user input, wherein the second user input modifies the first code sample in the first container to generate a first modified code sample, wherein the first modified code sample addresses a first vulnerability detected in the first code sample;
in response to receiving the second user input, executing the first rebuild code set on the first modified code sample;
after executing the first rebuild code set on the first modified code sample, validating the first container based on the first modified code sample; and
generating for display, on a third user interface, a first validation confirmation for the first container.

2. A method for minimizing software rebuild time during continuous integration and continuous deployment pipeline management using container-based code samples, the method comprising:
receiving a first user input for creating a first rebuild code set corresponding to a first code sample, wherein the first rebuild code set comprises one or more instructions for automatically rebuilding the first code sample following one or more modifications;
storing, in a first container, the first rebuild code set and the first code sample;
receiving a first modification request, wherein the first modification request modifies the first code sample in the first container to generate a first modified code sample;
in response to receiving the first modification request, executing the first rebuild code set on the first modified code sample; and
after executing the first rebuild code set on the first modified code sample, validating the first container based on the first modified code sample.

3. The method of claim 2, wherein executing the first rebuild code set on the first modified code sample further comprises:
determining, based on the first rebuild code set, an output requirement of the first container; and
modifying a first code string in the first modified code sample based on the output requirement.

4. The method of claim 2, wherein executing the first rebuild code set on the first modified code sample further comprises:
determining, based on the first rebuild code set, a dependency of the first container on a second code sample, wherein the second code sample is in a second container; and
modifying a first code string in the first modified code sample based on the dependency.

5. The method of claim 2, wherein executing the first rebuild code set on the first modified code sample further comprises:
determining, based on the first rebuild code set, a data source of the first container, wherein the data source comprises a second container; and
modifying a first code string in the first modified code sample based on the data source.

6. The method of claim 2, wherein executing the first rebuild code set on the first modified code sample further comprises:
determining, based on the first rebuild code set, a first validation test for the first container, wherein the first validation test is performed on the first container prior to deployment; and
modifying a first code string in the first modified code sample based on the first validation test.

7. The method of claim 2, wherein executing the first rebuild code set on the first modified code sample further comprises:
determining, based on the first rebuild code set, an error notification triggered in response to failure of the first container to be rebuilt; and
modifying a first code string in the first modified code sample based on the error notification.

8. The method of claim 2, wherein executing the first rebuild code set on the first modified code sample further comprises:
determining, based on the first rebuild code set, an application comprising the first container;
determining a validation test for the application, wherein the validation test is performed on the application prior to deployment; and
modifying a first code string in the first modified code sample based on the validation test.

9. The method of claim 2, wherein executing the first rebuild code set on the first modified code sample further comprises:
inputting the first rebuild code set into an artificial intelligence model, wherein the artificial intelligence model is trained on historic rebuild code sets and modified code samples; and
receiving an output from the artificial intelligence model, wherein the output comprises a modification to the first code sample and corresponds to the first modified code sample.

10. The method of claim 2, wherein executing the first rebuild code set on the first modified code sample further comprises:
determining, based on the first rebuild code set, an enforcement action for performing on an application comprising the first container in response to a validation failure of the first container; and
modifying a first code string in the first modified code sample based on the enforcement action.

11. The method of claim 2, wherein storing, in the first container, the first rebuild code set further comprises storing a container base image, a dependency library, and a compilation instruction.

12. The method of claim 2, wherein receiving the first modification request further comprises:
detecting a first security vulnerability in the first code sample; and
determining a modification to the first code sample to address the first security vulnerability.

13. The method of claim 2, wherein validating the first container based on the first modified code sample further comprises:
performing a first validation test on the first container in a container-specific environment; and
performing a second validation test on an application comprising the first container in an application-specific environment.

14. The method of claim 2, wherein validating the first container based on the first modified code sample further comprises:
retrieving a first test script for an application comprising the first container; and
processing the first test script in the application.

15. One or more non-transitory, computer-readable media, comprising instructions that, when executed by one or more processors, cause operations comprising:
receiving a first user input creating a first rebuild code set for corresponding to a first code sample, wherein the first rebuild code set comprises one or more instructions for automatically rebuilding the first code sample following one or more modifications;
storing, in a first container, the first rebuild code set and the first code sample;
receiving a first modification request, wherein the first modification request modifies the first code sample in the first container to generate a first modified code sample;
in response to receiving the first modification request, executing the first rebuild code set on the first modified code sample; and
after executing the first rebuild code set on the first modified code sample, validating the first container based on the first modified code sample.

16. The one or more non-transitory, computer-readable media of claim 15, wherein executing the first rebuild code set on the first modified code sample further comprises:
determining, based on the first rebuild code set, an output requirement of the first container; and
modifying a first code string in the first modified code sample based on the output requirement.

17. The one or more non-transitory, computer-readable media of claim 15, wherein executing the first rebuild code set on the first modified code sample further comprises:
determining, based on the first rebuild code set, a dependency of the first container on a second code sample, wherein the second code sample is in a second container; and
modifying a first code string in the first modified code sample based on the dependency.

18. The one or more non-transitory, computer-readable media of claim 15, wherein executing the first rebuild code set on the first modified code sample further comprises:
determining, based on the first rebuild code set, a data source of the first container, wherein the data source comprises a second container; and
modifying a first code string in the first modified code sample based on the data source.

19. The one or more non-transitory, computer-readable media of claim 15, wherein executing the first rebuild code set on the first modified code sample further comprises:
determining, based on the first rebuild code set, a first validation test for the first container, wherein the first validation test is performed on the first container prior to deployment; and
modifying a first code string in the first modified code sample based on the first validation test.

20. The one or more non-transitory, computer-readable media of claim 15, wherein executing the first rebuild code set on the first modified code sample further comprises:
inputting the first rebuild code set and the first modified code sample into an artificial intelligence model, wherein the artificial intelligence model is trained on historic rebuild code sets and modified code samples; and
receiving an output from the artificial intelligence model, wherein the output comprises a modification to the first code sample.
